(19) United States
(12) Patent Application Publication
(10) Pub. No.: US 2011/0055748 A1
(43) Pub. Date: Mar. 3, 2011

(54) SYSTEMS AND METHODS FOR MAPPING BUILDING MANAGEMENT SYSTEM INPUTS

(75) Inventor: Gheorghe L. Vacariuc, Arnold, MO (US)

(73) Assignee: Johnson Controls Technology Company

(21) Appl. No.: 12/874,961

(22) Filed: Sep. 2, 2010

Related U.S. Application Data
(60) Provisional application No. 61/239,738, filed on Sep. 3, 2009.

(51) Int. Cl. G05B 15/00; G06F 3/048

(52) U.S. Cl. 715/771; 700/275

(57) ABSTRACT

A building management system controller includes a memory device storing a template building object associated with a first set of building management system inputs. The system further includes a processing circuit configured to search building management system inputs that are not yet associated with a building management object for a second set of building management system inputs. The processing circuit is further configured to create a new building object in the memory device and to map the second set of building management system inputs to the new building object based on string searching.

### CROSS-REFERENCE TO RELATED APPLICATIONS

The present application claims the benefit of U.S. Provisional Application No. 61/239,738, filed Sep. 3, 2009, the entirety of which is hereby incorporated by reference.

### BACKGROUND

The present invention relates generally to the field of building management systems.

A building management system (BMS) is, in general, a system of devices configured to control, monitor, and manage equipment in or around a building or building area. A BMS can include a heating, ventilation, and air conditioning (HVAC) system, a security system, a lighting system, a fire alerting system, an elevator system, another system that is capable of managing building functions, or any combination thereof. BMS devices may be installed in any environment (e.g., an indoor area or an outdoor area) and the environment may include any number of buildings, spaces, zones, rooms, or areas. A BMS may include METASYS building controllers or other devices sold by Johnson Controls, Inc., as well as building devices and components from other sources.

A BMS may include one or more computer systems (e.g., servers, BMS controllers, etc.) that serve as enterprise level controllers, application or data servers, head nodes, master controllers, or field controllers for the BMS. Such computer systems may communicate with multiple downstream building systems or subsystems (e.g., an HVAC system, a security system, etc.) according to like or disparate protocols (e.g., LON, BACnet, etc.). The computer systems may also provide one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with the BMS, its subsystems, and devices.

### SUMMARY

One embodiment relates to a BMS controller for mapping a building object to BMS inputs. The BMS controller includes an interface configured to receive the building management system inputs. The BMS controller also includes a processing circuit configured to create a template building object and to map a first set of building management system inputs to the template building object based on user input received at the computing system. The processing circuit is further configured to search unmapped building management system inputs available at the interface for a second set of building management system inputs that are similar to the first set of building management system inputs. The processing circuit is further configured to create a new building object in memory associated with the computing system. The new building object is based on the template building object and the processing circuit is further configured to map the new building object to the second set of building management system inputs determined to be similar to the first set of building management system inputs based on the searching.

The searching conducted by the processing circuit can include finding relationships between the BMS inputs of the template building object. The searching may further include finding relationships between the BMS inputs of the template building object and an identifier for the template building object. The searching may yet further include applying the relationships between the BMS inputs of the template building object and the identifier to each unmapped BMS input and to use the application to group each unmapped BMS input into groups of potentially related BMS inputs. The searching may also include evaluating each permutation of BMS inputs in each group to determine whether the permutation is a match relative to the relationships between the BMS inputs of the template building object.

Another embodiment relates to a building management system controller. The building management system controller includes a memory device storing a template building object associated with a first set of building management system inputs. The building management system controller further includes a processing circuit configured to search building management system inputs that are not yet associated with a building management object for a second set of building management system inputs. The processing circuit is further configured to create a new building object in the memory device and to map the second set of building management system inputs to the new building object based on string searching. The string matching search utilized by the processing circuit comprises comparing string transformation permutations.

Another embodiment relates to a method of operation by a computer system and for mapping a building object in memory of the computing system to building management system inputs. The method includes creating a template building object in the memory of the computer system based on user input received by the computer system. The method further includes mapping a first set of building management system inputs to the template building object based on user input received at the computer system and storing the mapping in the memory of the computer system. The method also includes searching unmapped building management system inputs for a second set of building management system inputs that are similar to the first set of building management system inputs. The method also includes creating a new building object in the memory of the computer system based on the template building object. The method yet further includes mapping the new building object to the second set of building management system inputs determined to be similar to the first set of building management system inputs in the searching step.

In some embodiments of the method, the searching step can include determining whether an application of a transformation function to a character string for the second set of building management system inputs matches a character string for the first set of building management system inputs. The searching step may also or alternatively include determining string transformation functions between building management system inputs of the template building object. The searching step can also include comparing permutations of unmapped building management system inputs using the string transformation functions. The permutation comparisons based on the string transformation functions are used to determine the similarity between the first set of building management system inputs and the second set of building management system inputs.

In certain embodiments the method can include causing a plurality of building management system inputs that are similar to the first set of building management system inputs to be displayed on an electronic display communicably coupled to the computer system. The method may also include sorting the plurality of building management inputs for the display based on degree of similarity. The method may yet further include receiving user input at the computer system representing a user selection from the plurality of building management system inputs that are similar to the first set of building management system inputs. The creation of the new building object in the memory may be based on the user input. In some embodiments the search criteria for the template building object may be refined based on at least one of the creation of the new building object and a user selection. The method may further include calculating, using the computer system, a degree of confidence that a potential set of building management system inputs matches at least one of the first set of building management system inputs and search criteria generated for the template building object. In some embodiments the method may also include creating additional building objects in the memory based on the template building object and using the computer system to automatically map building management system inputs to the additional building objects when the calculated degree of confidence that the building management system inputs match the search criteria for the additional building objects exceeds a threshold degree of confidence. The method can also include displaying potential template building object and building management system inputs for user selection when the degree of confidence of the match does not exceed the threshold degree of confidence.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1A is a perspective view of a building including a BMS, according to an exemplary embodiment;

FIG. 1B is a block diagram of the BMS of the building shown in FIG. 1A, according to an exemplary embodiment;

FIG. 2A is a block diagram of a computer system or BMS controller for mapping BMS inputs to a new building object, according to an exemplary embodiment;

FIG. 2B is a flow chart of a process for mapping BMS inputs to a new building object, according to an exemplary embodiment;

FIG. 3A is a flow chart of a process for searching for unmapped BMS inputs that are similar to previously mapped BMS inputs (e.g., a BMS inputs of a template building object), according to an exemplary embodiment;

FIG. 3B is an illustration of a template building object and its relationship with a searching module shown in previous Figures, according to an exemplary embodiment; and

FIG. 4 is a more detailed flow chart of the process of FIG. 3A, according to another exemplary embodiment.

### DETAILED DESCRIPTION

Before turning to the figures, which illustrate the exemplary embodiments in detail, it should be understood that the disclosure is not limited to the details or methodology set forth in the description or illustrated in the figures. It should also be understood that the terminology is for the purpose of description only and should not be regarded as limiting.

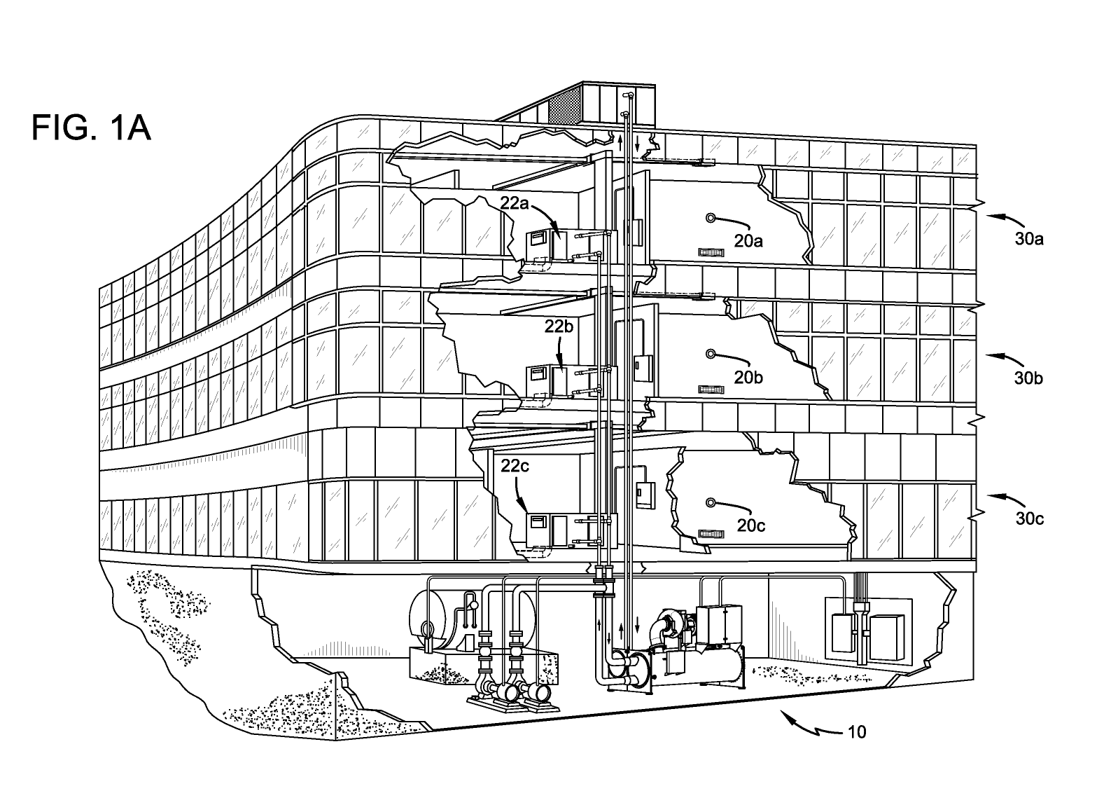

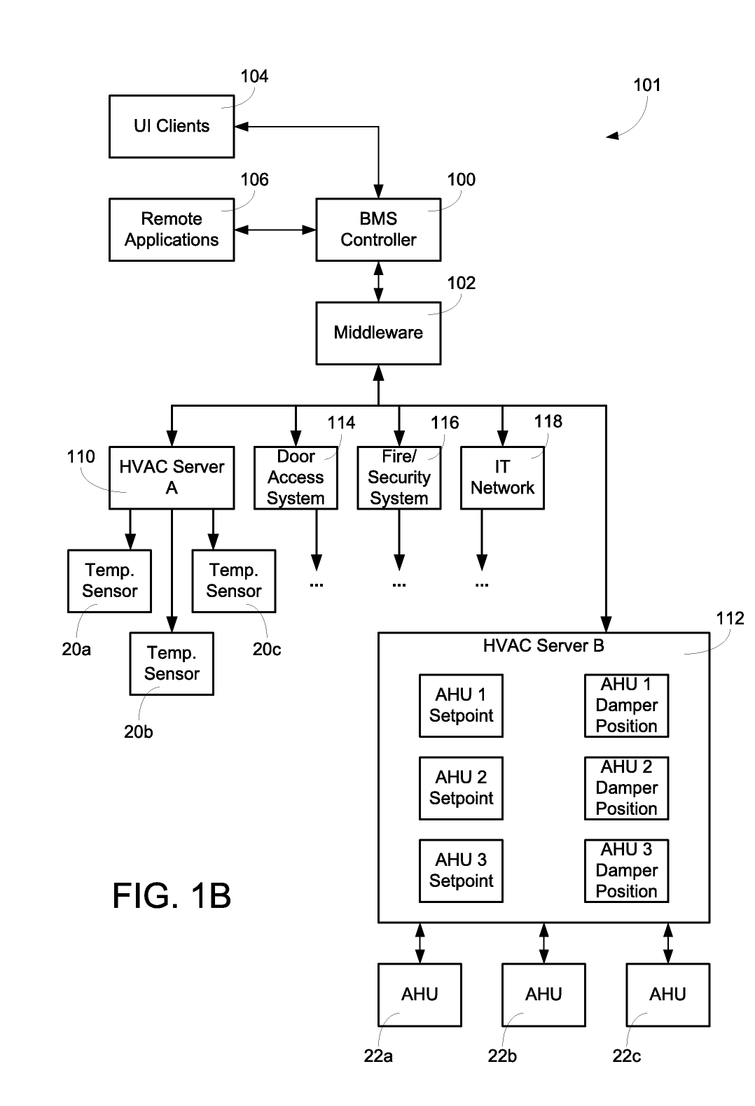

Referring now to FIG. 1A, a perspective view of a building 10 is shown, according to an exemplary embodiment. A BMS serves building 10. Building 10 is shown with three floors 30a, 30b, 30c. Each floor 30a, 30b, 30c is shown to include at least one physical air handling unit (AHU). Floor 30a is shown to include AHU 22a.Floor 30b includes AHU 22b. Floor 30c includes AHU 22c. Each floor 30a, 30b, 30c is also shown to include at least one temperature sensor. Floor 30a includes temperature sensor 20a. Floor 30b includes temperature sensor 20b. Floor 30c includes temperature sensor 20c.

While only a few devices are shown in the illustration of building 10, the BMS for building 10 may include any number or type of devices that serve the building. For example, each floor may include one or more security devices, video surveillance cameras, fire detectors, smoke detectors, lighting systems, or other building systems or devices.

In modern BMSs, BMS devices can exist on different networks within the building (e.g., one or more wireless networks, one or more wired networks, etc.) and yet serve the same building space or control loop. For example, AHU 22c and temperature sensor 20c may be connected to different communications networks although AHU 22c and temperature sensor 20c both serve first floor 30c. In some systems it may be desirable for a control strategy for first floor AHU 22c to use input from first floor temperature sensor 20c.

Referring to now FIG. 1B, a block diagram of an exemplary BMS 101 for building 10 of FIG. 1A is shown. BMS 101 is shown to include a plurality of BMS subsystems 110-118. Each BMS subsystem 110-118 is connected to a plurality of BMS devices and makes data points for varying connected devices available to upstream BMS controller 100.

As illustrated in FIG. 1 B, a BMS subsystem including HVAC server 110 “HVAC Server A” is connected to temperature sensors 20a, 20b, 20c. HVAC server 112 “HVAC Server B” is connected to AHUs 22a, 22b, 22c (e.g., connected to AHU controllers). HVAC server 112 receives data from AHUs 22a, 22b, 22c and stores a temperature setpoint and a damper position for each AHU in the server's memory. These variables are made available to BMS controller 100 as BMS inputs. BMS controller 100 may receive BMS inputs from temperature sensors 20a, 20b, 20c via HVAC server 110 and may receive BMS inputs from the AHUs 22a, 22b, 22c via HVAC server 112.

As shown in FIG. 1B, other BMS subsystems 114-118 are also connected to BMS controller 100. Door access system 114 may include devices that log entries and exits from scanned badges, check for authorized access, or conduct other door access related control activities. Fire/security system 116 may be connected to occupancy sensors, heat sensors, smoke detectors, or other fire or security devices. IT network 118 may include communications devices such as telephones, intercoms, desktop computing resources, wireless routers, switches, hubs, or other IT resources.

BMS subsystems 110-118 are shown as connected to BMS controller 100 via middleware 102 and are configured to provide BMS controller 100 with BMS inputs from the various BMS subsystems 110-118 and their varying downstream devices.

BMS controller 100 is configured to make differences in building subsystems transparent at the human-machine interface or client interface level (e.g., for connected or hosted user interface (UI) clients 104, remote applications 106, etc.). BMS controller 100 is configured to describe or model different building devices and building subsystems using common or unified building objects (e.g., software objects stored in memory) to provide the transparency. Benefits such as allowing developers to write applications that will work regardless of the building subsystem makeup may be provided by such software building objects. For example, although HVAC server 110 and HVAC server 112 are separate and may be disparately protocolled, BMS controller 100 may group the inputs from temperature sensor 20c and AHU 22c together to form a defined building object named “Floor1AHU.” Application code can be written and reused for “Floor1AHU” without concern for the particular input sources or protocols of the actual inputs. In an exemplary embodiment, “Floor1AHU”

To create a building object such as “Floor1AHU,” inputs from the BMS resources (e.g., subsystems, downstream devices, variables in memory, subscribed variables, pushed variables, etc.) received at BMS controller 100 may be mapped (e.g., linked, associated, described, grouped) to attributes of the building object.

A simplified exemplary result of such mapping might be a software object of an AHU described as:

Floor1AHU {

temperature_sensor: Floor1AHU.HVACserverA.TempS;
setpoint: Floor1AHU.HVACserverB.Setpoint;
damper_position: Floor1AHU.HVACserverB.Damper;

}

The building object's name is “Floor1AHU” which may conform to a naming convention indicating that it is the AHU serving the first floor of a building. The building object “Floor1AHU” has three values or attributes: temperature_sensor, setpoint, and damper_position that are mapped to the particular BMS resources of “Floor1AHU.HVACserverA.TempS,” “Floor1AHU.HVACserverB.Setpoint,” and “Floor1AHU.HVACserverB.Damper,” respectively. The mapping provides a description for BMS controller 100 or computing resources (e.g., back end software applications or client applications) so that the BMS or computing resources can identify, access, display, change, or otherwise interact with the particular BMS resources mapped to “Floor1AHU.”

As an example of how a building object may be used by the system, all AHUs serving a floor may have the same attributes as “Floor1AHU” listed above. Once each of the AHUs in building 10 are mapped to an AHU building object, the AHUs may be treated the same way in code existing in BMS controller 100, remote applications 106, or UI clients 104. Accordingly, an engineer writing software code for UI clients 104, remote applications 106 or BMS controller 100 can know that each AHU will have a temperature_sensor, a setpoint, and a damper_position attribute. Therefore, rather than having to know the a particular temperature sensor can be reached at Flood1AHU.HVACserverA.TempS, any given floor's temperature is available at the AHU's temperature_sensor attribute.

Building object operations are resolved using the mappings stored in BMS controller 100 and communications services available at BMS controller 100 or middleware 102. For example, when an application at remote applications 106 interacts with “Flood1AHU.temperature_sensor,” a communications service of BMS controller 100 or middleware 102 uses the stored mapping to generate communications (e.g., commands, requests, method initiations, etc.) for “Flood1AHU.HVACserverA.TempS.” As long as the mappings are correct (e.g., updated when the underlying BMS subsystems or BMS devices are changed), “virtual” building devices may be used and maintained by application code. For example, the actual AHU may not include a controller that has an addressable temperature sensor. However, grouping attributes of the AHU with a nearby temperature sensor can create a virtual building object (e.g., a more interactive or information-rich AHU) for use by application code.

While a building object may be mapped to inputs manually with a tool that requires a user to either type in or “drag and drop” BMS inputs to a object, embodiments of the present disclosure include computer systems and methods for automating some or all of a process for mapping of a building object to BMS inputs. Such embodiments may advantageously reduce the time and effort needed to organize a BMS having many hundreds or thousands of BMS inputs.

Referring generally to the Figures, a BMS controller for mapping a building object to BMS inputs is shown and described. The BMS controller is configured to use template building objects and mappings to search for groups of building management inputs that may form a building object. Proposed objects are presented to a user for feedback or confirmation as a building object.

In one exemplary embodiment, the BMS controller includes an interface configured to receive the BMS inputs. The BMS controller also includes a processing circuit configured to create a template building object and to map a first set of BMS inputs to the template building object based on user input received at the BMS controller. The processing circuit is further configured to search unmapped BMS inputs available at the interface for a second set of BMS inputs that are similar to the first set of BMS inputs. The processing circuit is further configured to create a new building object in memory associated with the BMS controller. The new building object is based on the template building object and the processing circuit is further configured to map the new building object to the second set of BMS inputs determined to be similar to the first set of BMS inputs based on the searching.

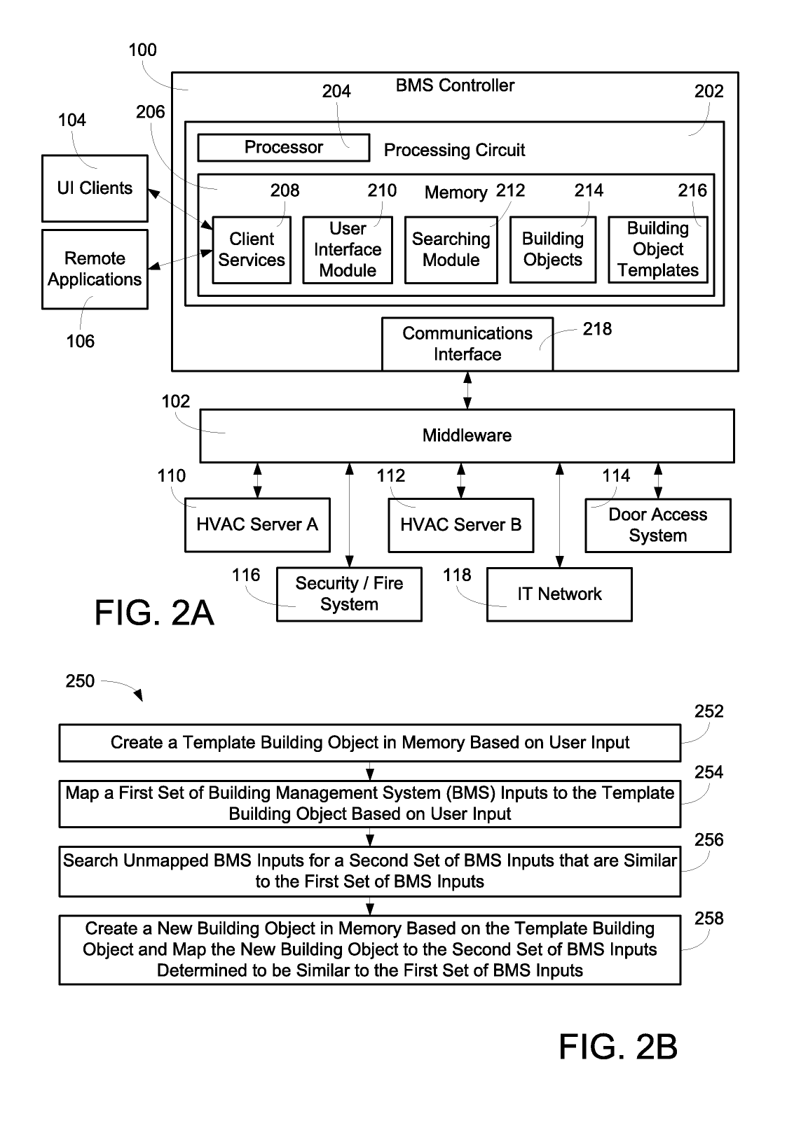

Referring now to FIG. 2A, a more detailed block diagram of a BMS controller 100 for mapping a building object to BMS inputs is shown, according to an exemplary embodiment. BMS controller 100 is shown to include a communications interface 218 in communication with middleware 102. Middleware 102 is generally a set of services that allow interoperable communication to, from or between similar or disparate subsystems of the BMS (e.g., HVAC servers 110, 112 from different manufacturers, HVAC servers 110, 112 that communicate according to different protocols, door access systems 114, security/fire systems 116, IT network 118, etc.). Middleware 102 may be, for example, an EnNet server sold by Johnson Controls, Inc. While middleware 102 is shown as separate from BMS controller 100 that maps building objects to BMS inputs, in various exemplary embodiments middleware 102 and BMS controller 100 are integrated. For example, middleware 102 may be a part of BMS controller 100.

Communications interface 218 can be or include wired or wireless interfaces (e.g., jacks, antennas, transmitters, receivers, transceivers, wire terminals, etc.) for conducting data communications with another system or network. For example, communications interface 218 can include an Ethernet card and port for sending and receiving data via an Ethernet-based communications network. In another example, communications interface 218 includes a WiFi transceiver for communicating via a wireless communications network. Communications interface 218 may be configured to communicate via local area networks or wide area networks (e.g., the Internet, a building WAN, etc.). Communications interface 218 is configured to receive building management inputs from middleware 102 or directly from one or more BMS subsystems. Communications interface 218 can include any number of software buffers, queues, listeners, or other communications-supporting services.

BMS controller 100 is shown to include a processing circuit 202 including a processor 204 and memory 206. Processor 204 may be a general or specific purpose processor, an application specific integrated circuit (ASIC), one or more field programmable gate arrays (FPGAs), a group of processing components, or other suitable processing components. Processor 204 configured to execute computer code or instructions stored in the memory or received from other computer readable media (e.g., CDROM, network storage, a remote server, etc.). According to an exemplary embodiment, memory 206 is communicably connected to processor 204 via electronics circuitry. Memory 206 (e.g., memory unit, memory device, storage device, etc.) is one or more devices for storing data and/or computer code for completing and/or facilitating the various processes described in the present disclosure. Memory 206 may be RAM, hard drive storage, temporary storage, non-volatile memory, flash memory, optical memory, or any other suitable memory for storing software objects and/or computer instructions. Memory 206 may include database components, object code components, script components, or any other type of information structure for supporting the various activities and information structures described in the present disclosure. Memory 206 includes computer code for executing (e.g., by processor 204) one or more processes described herein. When processor 204 executes instructions stored in memory 206 for completing the various activities described herein, processor 204 generally configures computer system 200 and more particularly processing circuit 202 to complete such activities.

Memory 206 is shown to include client services 208. Client services 208 allow interaction between internal or external clients or applications and BMS controller 100. Client services 208, for example, may include web services or application programming interfaces available for communication with UI clients 104 and remote applications 106 (e.g., an energy monitoring application, an application allowing a user to monitor the performance of the BMS, an automated fault detection and diagnostics system, etc.).

Memory 206 further includes user interface module 210. User interface module 210 is configured to generate one or more user interfaces for receiving input from a user. User interface module 210 may be configured to provide, for example, a graphical user interface, a voice driven interface, a text-based interface, or another interface for receiving user input regarding the mapping of BMS inputs to building objects. In an exemplary embodiment, user interface module 210 is an HTML-based application configured to be served by, for example, client services 208 or another web server of BMS controller 100 or another device. User interface module 210 may be configured to prompt a user (e.g., visually, graphically, audibly, etc.) for input regarding building objects. In an exemplary embodiment, user interface module 210 prompts the user to create (or otherwise provides a user interface for creating) a template building object. User interface module 210 may also prompt the user to map BMS inputs to the template building object. User interface module 210 may receive and handle the user inputs to initiate the storage of received input mappings and mapping between the links and the template building object. User interface module 210 may be configured to receive a plurality of template building objects and a plurality of initial mappings prior to beginning a search routine conducted by searching module 212. In varying exemplary embodiments the search routine can be fully automated or partially-automated.

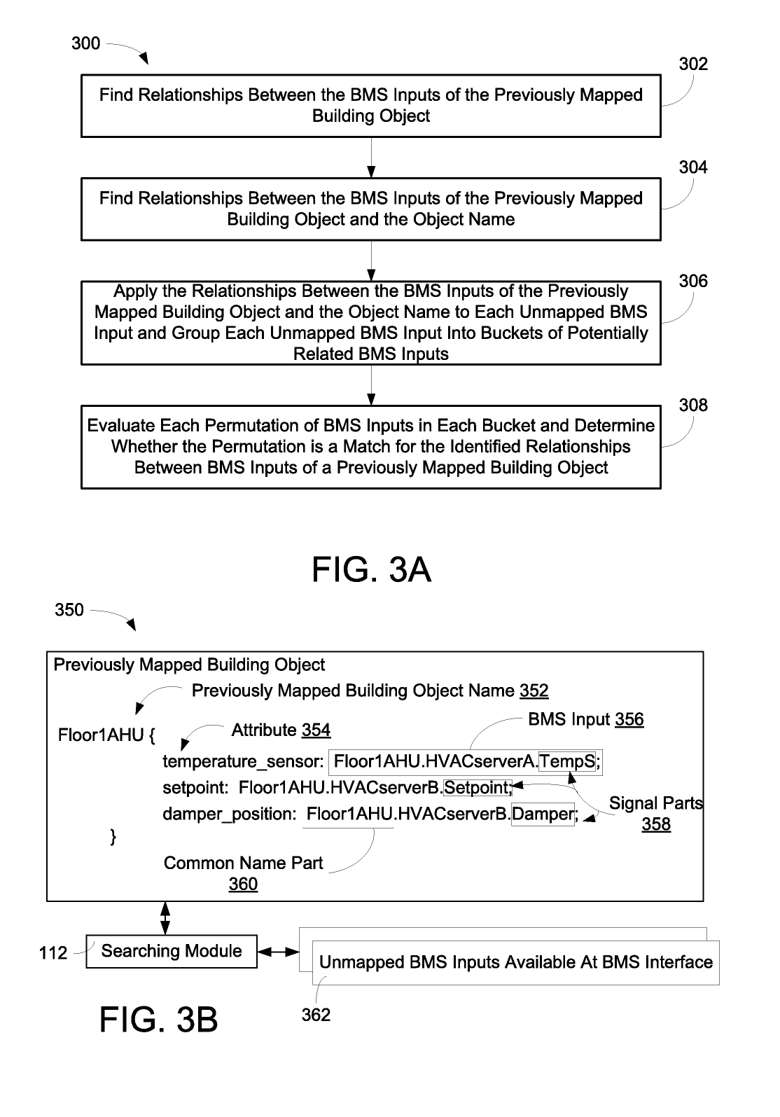

Memory 206 includes searching module 212. Searching module 212 is configured to search unmapped BMS inputs for previously unmapped inputs that are similar to mappings created by the user using user interface module 210. Searching module 212 may use a variety of different searching methods or algorithms according to various exemplary embodiments. One such algorithm is shown in FIGS. 3A-B. Searching module 212 may select a match as the result of its searching or a plurality of possible matches (e.g., sorted by match probability or fit). Matches or probable matches may be shown to the user via user interface module 210 for confirmation or user selection. In other exemplary embodiments BMS controller 100 or searching module 212 automatically completes matches of template building objects to BMS inputs. In response to the user selection or computerized selection of the search results, searching module 212 may be configured to create a new building object in memory (e.g., a new instance of a building object) by mapping the new building object to the “matches” or BMS inputs determined to be appropriate for the building object by searching module 212. BMS objects and their mappings are stored in memory 206 as building objects 214. Building object templates 216 (e.g., one or more objects having full mappings) are also stored in memory 206.

Modules in addition to user interface module 210 and searching module 212 may be provided in memory 206 to complete the one or more steps or substeps of the activities described herein. The modules may be or include executable computer code or instructions for completing the activities described with reference to each module when executed (e.g., by processor 204). For example, a supervisory object creation module may be the main routine or otherwise coordinate activities of user interface module 210 and searching module 212.

Referring now to FIG. 2B, a flow chart of a process 250 for operation by a BMS controller (e.g., the BMS controller shown in FIG. 2A) and for mapping a building object in memory of the BMS controller to BMS inputs is shown, according to an exemplary embodiment. Process 250 is shown to include creating a template building object in memory based on user input (e.g., user input prompted for and/or received by the user interface module shown in FIG. 2A) (step 252). Creating a template building object in memory may include defining or describing a class, its attributes, and methods. In other embodiments, creating a template building object in memory includes selecting from one or more pre-created or “stock” building objects. In yet other embodiments, a user may designate one or more “live” building objects as templates to use as examples or in further searching.

Process 250 is further shown to include mapping a first set of BMS inputs to the template building object based on user input (e.g., user input received at the user interface module) (step 254). Mapping BMS inputs to the template building object may include creating or using an instance of the class or template created in step 252 and associating fully described BMS input “paths” or “points” to the attributes or methods of the instantiated object. For example, a character delimited BMS input string may mapped (e.g., associated with in memory, linked in memory) to the template building object. The building object and mappings resulting from step 254 may be stored in the memory of the BMS controller or a remote memory system.

Process 250 is further shown to include searching unmapped BMS inputs for a second set of BMS inputs that is similar to the first set of BMS inputs (step 256). Process 250 is yet further shown to include creating a new building object in the memory of the BMS controller based on the template building object and mapping the new building object to the second set of BMS inputs determined to be similar to the first set of BMS inputs in the searching step (step 258). In an exemplary embodiment, the searching and creating steps of the process shown in FIG. 2B may be repeated until no further “matches” for unmapped BMS inputs are identified.

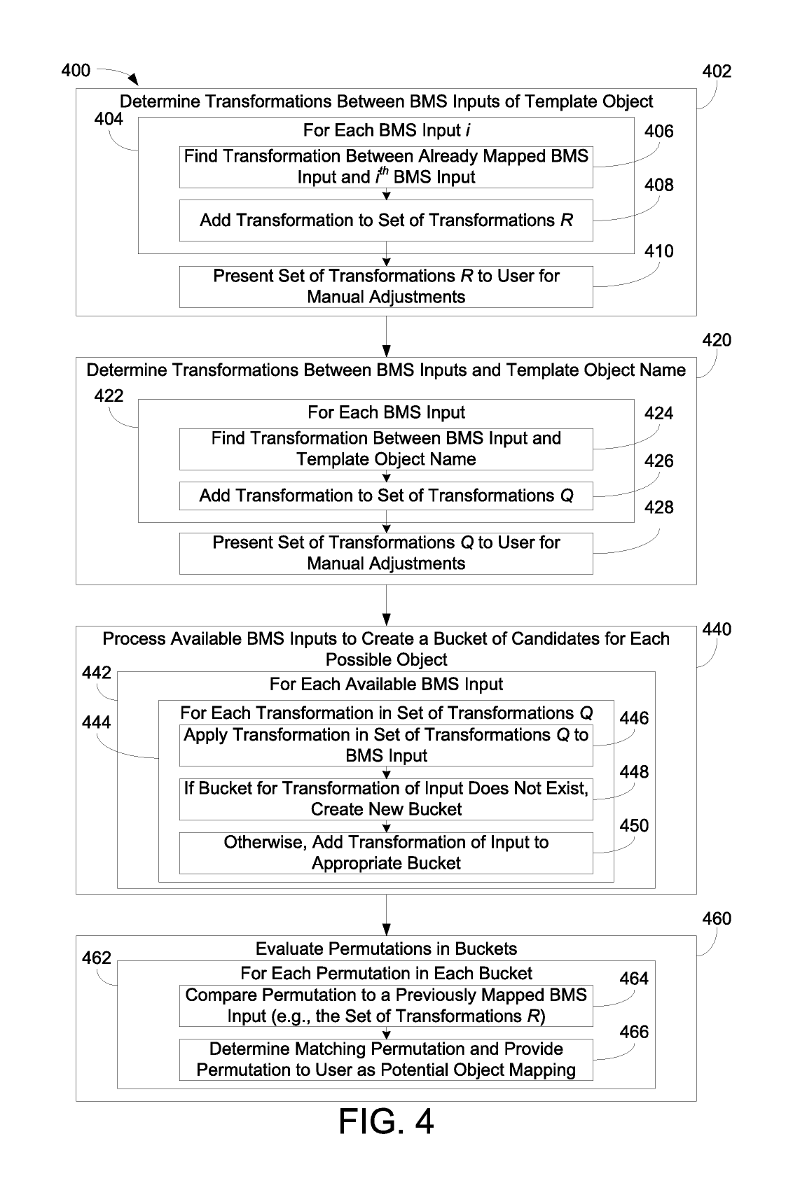

Process 250 may further include causing a plurality of BMS inputs that are determined to be similar to the first set of BMS inputs in the searching step to be displayed on an electronic display (e.g., a display of UI clients 104 communicably coupled to BMS controller 100). Process 250 may further include sorting the plurality of building management inputs for the display based on degree of similarity. Process 250 can also include receiving a user input representing a user selection from the plurality of building management system inputs that are similar to the first set of building management system inputs. User input to the process 250 may be leveraged in yet other ways. For example, user input may be used to refine search criteria for the template building object. In some embodiments, the searching step completes without any user input. The detailed view of an exemplary searching step shown in FIG. 4 illustrates some exemplary user-input points (e.g., user input to allow for adjustment of string transformations to be searched, user input to allow for confirmations or denials of BMS permutation matching, etc.).

In other embodiments of process 250, the BMS controller may use varying levels of user input based on the quality of the automated searching or fitting of unmapped inputs to template inputs. For example, process 250 may include the BMS controller calculating a degree of confidence that a potential set of BMS inputs matches the first set of building management system inputs or other search criteria generated for the template building object. Process 250 can take one set of steps if a detected degree of confidence of a match is high (e.g., exceeds a threshold) and another set of steps if an automatically detected degree of confidence of a match is low. For example, if the degree of confidence of a match is high, process 250 may automatically map BMS inputs to a newly created building object. Such automated mapping may be user confirmed or completed without user confirmation (e.g., if the confidence of the match is very high). If the degree of confidence of a match is not high then process 250 may seek further user-feedback. For example, process 250 may include displaying potential template building object and building management system inputs for user selection when the degree of confidence of the match does not exceed the threshold degree of confidence.

Referring now to FIGS. 3A-B, a flow chart of a process 300 and an accompanying block diagram 350 for searching unmapped BMS inputs are shown, according to an exemplary embodiment. Process 300 may be completed by searching module 212 of FIG. 2A and correspond with step 256 of process 250 of FIG. 2B. In other words, process 300 is for searching unmapped BMS inputs for BMS inputs that are similar to previously mapped BMS inputs. For example, referring also to FIG. 3B, process 300 may search the BMS inputs 356 of the previously mapped building object “Floor1AHU.” The building object has three attributes 354 that are each mapped to a particular BMS resource (e.g., the temperature_sensor attribute is mapped to “Floor1AHU.HVACserverA.TempS”).

Process 300 includes finding relationships between the BMS inputs of a previously mapped building object (step 302). For example, referring also to FIG. 3B, the transformation functions between “Flood1AHU.HVACserverA.TempS” and “Floor1AHU.HVACserverB.Setpoint” and between “Floor1AHU.HVACserverB.Setpoint” and “Floor1AHU.HVACserverB.Damper” are determined and stored. A variety of different methods may be used to determine and store appropriate string transformations. For example, the transformations may be described and stored using regular expressions, machine learning, prefix/suffix extraction, or other suitable methods for determining, describing, and storing transformations between strings. Any number of normalization or preparation steps may be conducted prior to or after determining substantive transformations. For example, prior to attempting to determine substantive transformations, characters or portions of the string may be actively removed. In other embodiments the transformation determination will ignore certain characters (e.g., improper characters, portions of the transformation string marked for removal, etc.) during transformation related processing.

Process 300 is further shown to include finding relationships between the BMS inputs of the previously mapped building object and the object name (step 304). Step 304 may include determining a transformation function between the BMS inputs and the object name and identifying the transformation as the relationship. For example, referring to FIG. 3B, for the temperature_sensor attribute, the transformation function from “Floor1AHU.HVACserverA.TempS” to “Floor1AHU” would be the removal of the string “HVACserverA.TempS” after the first period of the BMS input. The transformation function may include a removal of one or more signal parts 358 from other signal parts (e.g., the removal of “TempS” from the temperature_sensor attribute's mapped device string). Aspects other than the initial string or prefix may be found using step 304 (e.g., a common name part 360, common middle part of the string, a common floor name, a common device name, a common server, a common suffix, a common IP address, etc.).

Process 300 is further shown to include applying the relationships found in step 304 (the relationships between the previously mapped building object and the object name) to each unmapped BMS input 362 available at a BMS interface. The unmapped BMS inputs are grouped into buckets of potentially related BMS inputs based on the results from applying the relationships (step 306). For example, if step 304 finds a relationship where the prefix of a BMS input matches the object name (e.g., “Floor1AHU”), step 306 may group BMS inputs having like prefixes in a bucket (e.g., a queue, linked list, array, or other data structure for later processing).

Process 300 further includes evaluating each permutation of BMS inputs in the buckets from step 306 and checking for whether a permutation of BMS inputs is a match for the relationship set found in step 302 (step 308). For example, for each bucket or list, step 308 may include checking each permutation of BMS inputs in the bucket and choosing the permutation that reflects the BMS input-to-BMS input transformations of the template object.

Process 300 may further include, for each potential building object, selecting the object name for the new building object. For example, for each bucket or list of potential BMS inputs, the most frequent result of the transformation functions applied to the BMS inputs may be selected as the object name (e.g., the name that most frequently shows up in the BMS inputs may be chosen).

For each potential group or list of BMS inputs, the group may be dropped from consideration if results of the analysis in steps 306, 308 indicate a poor match or fit. For example, if a BMS input is alone in a bucket, the BMS input may be tagged as a standalone input for human analysis rather than automated or quasi-automated mapping.

It should be noted that other searching or matching algorithms may be used. For example, in some embodiments, class attribute names may be compared to BMS input strings (e.g., the attribute name “temperature_sensor” may be used to search for BMS inputs having the string “temp”). The searching may also or alternatively include any number of steps that do not include string or name comparisons. For example, BMS input types and value ranges may be considered and/or patterns in BMS input value relationships may be considered. Yet further, other name matching algorithms may be used in addition to or instead of that shown in FIGS. 3A-B. Further, as will be explained with reference to FIG. 4, user input may supplement or complement the computer-based processing to handle anomalies.

Referring now to FIG. 4, a more detailed flow chart of the process of FIG. 3A is shown, according to an exemplary embodiment. Process 400 includes determining transformations between template signals (e.g., finding the relationships between the template signals as described in step 302 of FIG. 3A) (step 402). Step 402 includes, for each template BMS input (step 404), finding a transformation between the template BMS input and an already mapped template BMS input (step 406). The function for finding the transformation may be implemented as a machine learning algorithm, a static algorithm, or any other suitable method. The function may use an initial repository of expressions to conduct the comparison or to describe the transformation functions. The functions that finds transformation functions may ignore certain characters, ignore ranges of characters, or otherwise normalize the BMS input strings for more accurate processing despite disjoint naming conventions or other string characteristics.

The transformation found in step 406 is added to a set of transformations R (step 408). The set of transformations includes all transformations between template BMS inputs (e.g., the differences of each string for each attribute of the template object) of the template object. The set of transformations may be provided to a user for manual adjustments to the transformation set (step 410). For example, manual adjustments by a user may include removing or modifying transformations in the transformation set.

Process 400 further includes determining transformations between template BMS inputs and the template object name (step 420). Step 420 includes, for each template BMS input (step 422), finding a transformation between the template BMS inputs and the template object name (step 424). For example, referring to FIG. 3B, the transformation between the template BMS input of “HVACserverA.TempS” and the template BMS object name of “Floor1AHU” is the deletion of “HVACserverA.TempS” from the BMS input string.

The transformation found in step 424 is added to a set of transformations Q (step 426). A transformation is stored for each attribute of the template BMS object. For example, referring to FIG. 3B, the set of transformations includes the following: the deletion of the “HVACserverA.TempS” string, the deletion of the “HVACserverB.Setpoint” string, and the deletion of the “HVACserverB.Damper” string. The set of transformations may be provided to a user for manual adjustments to the transformation set (step 428). For example, manual adjustments by a user may include removing or modifying transformations in the transformation set.

Process 400 further includes processing available BMS inputs (e.g., the various signals not already mapped to a building object) to create a bucket of candidates for each possible object (step 440). For each available BMS input (step 442) and for each possible transformation Q found in step 420 (step 444), the transformation is applied to the BMS input (step 446). The transformed signal is then added to a bucket representing a possible building object (step 450). For example, if the transformed signal is “Floor2AHU.HVACserverA.TempS” and the transformation is the deletion of “HVACserverA.TempS”, the transformed signal may be placed in a list or bucket as a potential candidate to be mapped to the building object with name Floor2AHU. If a list or bucket does not exist for a potential building object (e.g., a particular transformation application), the list or bucket is created (step 448).

Process 400 further includes evaluating the BMS input permutations in each list or bucket created in step 440 (step 460). For each permutation in each bucket (step 462), the permutation is compared to a BMS input-to-BMS input relationship described by the transformations in R (step 464). Once a matching permutation is determined or found, the permutation is provided to a user as a potential object mapping (step 466).

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A computer system for mapping a building object to building management system inputs, comprising:
an interface configured to receive the building management system inputs; and
a processing circuit configured to create a template building object and to map a first set of building management system inputs to the template building object based on user input received at the computing system;
wherein the processing circuit is further configured to search unmapped building management system inputs available at the interface for a second set of building management system inputs that are similar to the first set of building management system inputs;
wherein the processing circuit is further configured to create a new building object in memory associated with the computing system;
wherein the new building object is based on the template building object; and
wherein the processing circuit is further configured to map the new building object to the second set of building management system inputs determined to be similar to the first set of building management system inputs based on the searching.

2. The computer system of claim 1, wherein the processing circuit is configured to determine whether the first set of building management system inputs are similar to the second set of building management system inputs by determining whether an application of a transformation function to a character string for the second set of building management system inputs matches a character string for the first set of building management system inputs.

3. The computer system of claim 1, wherein the processing circuit is configured to determine string transformation functions between building management system inputs of the template building object;
wherein the processing circuit is configured to compare permutations of unmapped building management system inputs using the string transformation functions; and
wherein the permutation comparisons based on the string transformation functions are used to determine the similarity between the first set of building management system inputs and the second set of building management system inputs.

4. The computer system of claim 1, wherein the processing circuit is further configured to cause a plurality of building management system inputs that are similar to the first set of building management system inputs to be displayed on an electronic display communicably coupled to the computer system;
wherein the processing circuit is further configured to sort the plurality of building management inputs for the display based on degree of similarity;
wherein the processing circuit is configured to receive a user input at the computer system representing a user selection from the plurality of building management system inputs that are similar to the first set of building management system inputs; and
wherein the processing circuit is configured to complete the mapping in response to the received user input.

5. The computer system of claim 1, wherein the processing circuit is configured to provide a representation of a set of automatically determined search criteria to an electronic display, the set based entirely on the template building object, and wherein the processing circuit is configured to modify the search criteria using user input received from a user input device connected to the processing circuit.

6. The computer system of claim 1, wherein the processing circuit is configured to calculate, using the computer system, a degree of confidence that a potential set of building management system inputs matches at least one of the first set of building management system inputs and search criteria generated for the template building object.

7. The computer system of claim 1, wherein the processing circuit is further configured to create additional building objects in the memory based on the template building object and to automatically map building management system inputs to the additional building objects when the calculated degree of confidence that the building management system inputs match the search criteria for the additional building objects exceeds a threshold degree of confidence.

8. The computer system of claim 7, wherein the processing circuit is further configured to display potential template building object and building management system inputs for user selection when the degree of confidence of the match does not exceed the threshold degree of confidence.

9. The computer system of claim 1, wherein the searching conducted by the processing circuit comprises:
finding relationships between the building management system (BMS) inputs of the template building object;
finding relationships between the BMS inputs of the template building object and an identifier for the template building object;
applying the relationships between the BMS inputs of the template building object and the identifier to each unmapped BMS input and to use the application to group each unmapped BMS input into groups of potentially related BMS inputs; and
evaluating each permutation of BMS inputs in each group to determine whether the permutation is a match relative to the relationships between the BMS inputs of the template building object.

10. A method of operation by a computer system and for mapping a building object in memory of the computing system to building management system inputs, the method comprising:
creating a template building object in the memory of the computer system based on user input received by the computer system;
mapping a first set of building management system inputs to the template building object based on user input received at the computer system and storing the mapping in the memory of the computer system;
searching unmapped building management system inputs for a second set of building management system inputs that are similar to the first set of building management system inputs;
creating a new building object in the memory of the computer system based on the template building object; and
mapping the new building object to the second set of building management system inputs determined to be similar to the first set of building management system inputs in the searching step.

11. The method of claim 10, wherein the searching step comprises:
determining whether an application of a transformation function to a character string for the second set of building management system inputs matches a character string for the first set of building management system inputs.

12. The method of claim 10, wherein the searching step comprises determining string transformation functions between building management system inputs of the template building object;
wherein the searching step further comprises comparing permutations of unmapped building management system inputs using the string transformation functions; and
wherein the permutation comparisons based on the string transformation functions are used to determine the similarity between the first set of building management system inputs and the second set of building management system inputs.

13. The method of claim 10, further comprising:
causing a plurality of building management system inputs that are similar to the first set of building management system inputs to be displayed on an electronic display communicably coupled to the computer system;
sorting the plurality of building management inputs for the display based on degree of similarity; and
receiving a user input at the computer system representing a user selection from the plurality of building management system inputs that are similar to the first set of building management system inputs.

14. The method of claim 10, further comprising:
using the computer system to refine the search criteria for the template building object based on at least one of the creation of the new building object and the user selection.

15. The method of claim 10, further comprising:
calculating a degree of confidence that a potential set of building management system inputs matches at least one of the first set of building management system inputs and search criteria generated for the template building object.

16. The method of claim 15, further comprising:
creating additional building objects in the memory based on the template building object and automatically mapping building management system inputs to the additional building objects when the calculated degree of confidence that the building management system inputs match the search criteria for the additional building objects exceeds a threshold degree of confidence.

17. The method of claim 16, further comprising:
displaying potential template building object and building management system inputs for user selection when the degree of confidence of the match does not exceed the threshold degree of confidence.

18. The method of claim 10, wherein the searching step completes without user input.

19. A building management system controller, comprising:
a memory device storing a template building object associated with a first set of building management system inputs; and
a processing circuit configured to search building management system inputs that are not yet associated with a building management object for a second set of building management system inputs, wherein the search comprising string matching;
wherein the processing circuit is further configured to create a new building object in the memory device and to map the second set of building management system inputs to the new building object based on the string searching.

20. The building management system controller of claim 19, wherein the string matching search utilized by the processing circuit comprises comparing string transformation permutations.
